(19) United States
(12) Patent Application Publication
(10) Pub. No.: US 2024/0351888 A1
(43) Pub. Date: Oct. 24, 2024

(54) METHOD FOR PRODUCING A SILICON ELECTRODE AS AN ANODE FOR A LITHIUM BATTERY

(71) Applicant: NORCSI GMBH, Halle (DE)

(72) Inventors: Udo REICHMANN, Wilsdruff (DE); Marcel NEUBERT, Kreischa (DE); Andreas KRAUSE-BADER, Dresden (DE)

(73) Assignee: NORCSI GMBH, Halle (DE)

(21) Appl. No.: 18/681,995

(22) PCT Filed: Aug. 9, 2022
(86) PCT No.: PCT/EP2022/072293

§ 371 Date: Feb. 7, 2024

(30) Foreign Application Priority Data
Aug. 9, 2021 (DE) 10 2021 120 615.4
Aug. 9, 2021 (DE) 10 2021 120 624.3
Aug. 9, 2021 (DE) 10 2021 120 635.9
Oct. 13, 2021 (DE) 10 2021 126 477.4

(51) Int. Cl. C01B 33/06; H01M 4/02; H01M 4/38; H01M 10/0525

(52) U.S. Cl. CPC C01B 33/06; H01M 4/38; H01M 10/0525; H01M 2004/028

(57) ABSTRACT

The invention relates to a method for producing a silicon electrode as an anode for a lithium-ion battery in which a silicon layer structure is applied to a carrier substrate. The problem addressed by the invention of specifying a method which is suitable for introducing additional lithium into the silicon electrode as an anode, in particular to compensate for initial losses during battery use and which is suitable for industrial use, is solved in that the silicon electrode is subjected to pre-lithiation in which lithium is introduced into the silicon layer structure through a process, in that a protective layer is applied and in that the introduced lithium is subjected, in a regulated and diffusion-controlled manner, through subsequent rapid annealing using a targeted application of energy, to a reaction with the silicon layer structure to produce lithium silicide.

The invention relates to a method for producing a silicon electrode as an anode for a lithium battery.

Batteries are electrochemical energy stores and are differentiated as primary and secondary batteries; general principles and key features of lithium (Li)-ion batteries have been published collectively in a compendium by Verein Deutscher Ingenieure (VDE), from which certain principles have been taken (see https://www.dke.de/resource/blob/933404/dd44d15918ce4d4aefc363a4ef1490e1/kompend ium-li-io-batterien-2021-de-data.pdf-2022-01-20).

Primary batteries are electrochemical power sources in which chemical energy is converted irreversibly into electrical energy. A primary battery is therefore not rechargeable. Secondary batteries, also called accumulators, on the other hand, are rechargeable electrochemical energy stores in which the chemical reaction that takes place is reversible, enabling multiple use. During charging, electrical energy is converted into chemical energy, and on discharge it is converted back from chemical to electrical energy.

A respective coherent, complete charging and discharge procedure is referred to as a cycle. The life of a battery is linked to the number of cycles. The life of rechargeable batteries varies with type, usage, and handling. Lithium-ion batteries are robust and have high cycling stability and a large energy density.

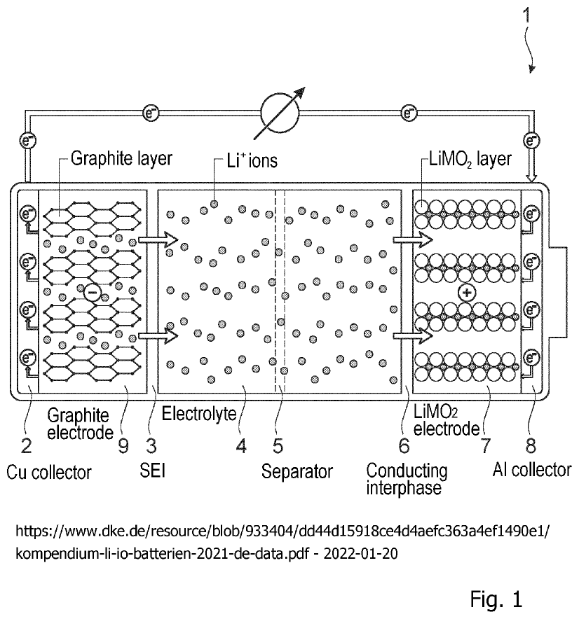

“Battery” is the headline term for interconnected cells. Cells are galvanic units which consist of two electrodes, electrolyte, separator, and cell casing. FIG. 1 shows an illustrative construction and the function of a lithium-ion cell during discharging. The constituents of a cell are briefly elucidated below.

Each Li-ion cell consists of two different electrodes 7, 9: an electrode 9, which is negatively charged in the charged state, and an electrode 7, which is positively charged in the charged state. Since release of energy, in other words discharge, is accompanied by migration of ions from the negatively charged electrode to the positively charged electrode, the positively charged electrode is called the cathode 7 and the negatively charged electrode is called the anode 9. The electrodes are each composed of a current collector 2, 8 and of an active material applied thereon. Located between the electrodes are firstly the ion-conducting electrolyte 4, which enables the required exchange of charge, and the separator 5, which ensures electrical separation of the electrodes.

The anode of the Li-ion cell may consist of a copper foil and of a layer of carbon. The carbon compound used is usually natural or synthetic graphite, as it possesses a low electrode potential and exhibits little volume expansion during charging and discharging. During charging, lithium ions are reduced and intercalated into the graphite layers.

Also known with Li battery anodes is the use of silicon rather than carbon. Silicon is a particularly suitable anode material for lithium batteries owing to the maximum storage capacity of in theory up to 4200 mAh/g.

The cathode consists, for example, of mixed oxides applied on an aluminum collector. Transition metal oxides with cobalt (Co), manganese (Mn) and nickel (Ni) or aluminum oxide (Al₂O₃) are the most common compounds here. The applied metal oxide layer serves for intercalation of the lithium ions during discharge of the cell.

In constructions for lithium-ion batteries, the cathode typically supplies the lithium atoms for charging and discharge in the anode, and hence the battery capacity is limited by the cathode capacity. Typical cathode materials used to date are, for example, Li (Ni,Co,Mn)O₂and LiFePO₄. Because of the construction of the cathode by lithium metal oxides, possibilities for boosting the capacity are only minimal.

It is known that preliminary lithiation or else prelithiation of the silicon anode represents one suitable possibility for compensating lithium losses, particularly in the initial cycles, and for ensuring lithium retention during operation. Lithiation refers to the intercalation of the lithium ions in the host material, for example the silicon or the graphite. However, prelithiation is a complicated process. In an electrochemical prelithiation process, an Li metal electrode and the anode are isolated from one another electronically and the anode is charged with a low current or an electrical short circuit in order to perform lithiation. This procedure may be repeated for multiple charging/discharge cycles, for a defined duration, or until the anode attains a defined potential. The electrochemical prelithiation process, however, requires a step of reinstalling the prelithiated anode into the lithium-ion battery cell, and this increases the complication and reduces the possibility of employing this method commercially.

Another possibility for performing prelithiation is to use stabilized Li metal powder. However, the addition of lithium must be metered exactly so that no residue of lithium is left after installation; this is very difficult to control owing to slight fluctuations in layer homogeneity. Another disadvantage is the use of highly reactive Li metal, meaning that the entire process of electrode production or at least parts of the process have to be performed under dry atmosphere conditions, so further increasing the costs of lithium-ion battery (LIB) cell production.

A different possibility for prelithiation is to add an excess of lithium salts to the electrolyte in the cell. However, this alters the cell parameters, particularly the conductivity of the electrolyte. This is undesirable in the operation of the LIB.

Referring to FIG. 1, discharge sees lithium ions migrate from the anode through the electrolyte and separator to the cathode, where they are reversibly intercalated. As a result of the oxidation process taking place at the anode, electrons are released. They flow from the negatively charged anode via an external electrical connection to the positive cathode, at which, accordingly, a reduction process takes place and electrons are taken up. The external current flow allows electrical consumers to be operated. On charging, the process is exactly the opposite.

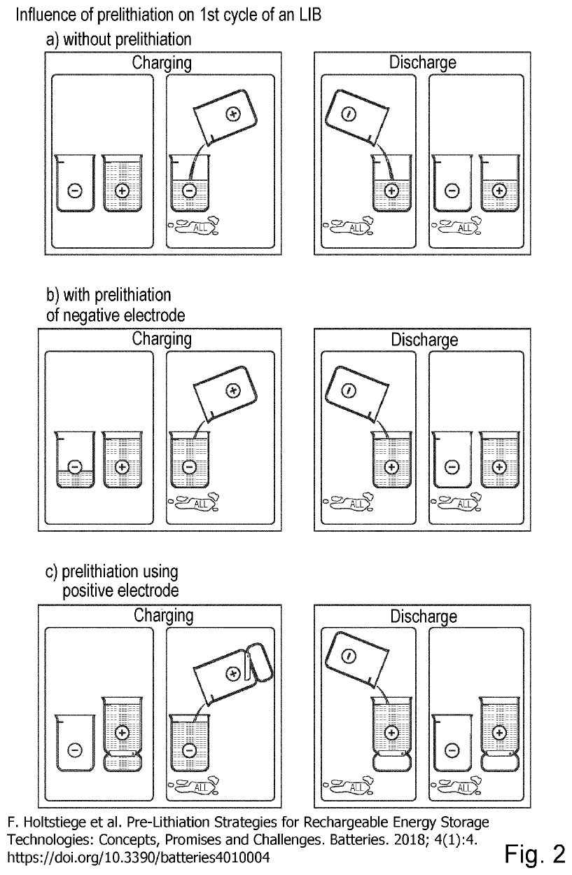

During charging and discharging, the electrolyte acts as a mediator between the reactions at the electrodes and guarantees the transport of Li ions. In so doing, it is required to have high ion conductivity and to be stable in the voltage range from 0 to 4.5 V relative to Li/Li+ as reference and also in the temperature range in which the battery is to be operated. There are liquid electrolytes, polymer electrolytes and solid electrolytes, and mixtures (hybrid cells) of these. In suitable liquid and polymerized electrolytes, a covering layer is formed on carbon-based anodes but also directly on silicon or other electrodes: what is known as the solid-electrolyte interphase (SEI). This protects the anode from the corrosive electrolyte solution and at the same time is permeable to lithium ions. This layer is essential for the use of lithium and lithium-ion intercalation compounds in primary and secondary cells. In the initial cycles of battery operation, however, the buildup of the SEI layer entails a loss of free lithium ions, which are then no longer available for operation. This is why the aforementioned prelithiation is employed, and its influence is represented illustratively in FIG. 2. The reservoir of lithium in the cathode is limited. The introduction of additional lithium into the anode by prelithiation thus makes it possible to compensate otherwise unavoidable losses. FIG. 2c shows that the storage capacity of the cathode is exhausted; beyond this, no excess of lithium can be introduced.

The separator separates the two electrodes from one another in order to prevent an electrical short circuit resulting from direct contact. Materials used are, for example, polymer membranes or ceramic separators, or nonwovens and glass fiber separators.

The energy density is a measure of the energy content of a cell or a battery per unit of volume or mass. Consequently, for example, it has a direct influence on the achievable range of a purely electrically driven vehicle with a traction battery of given mass or given volume, and is described as specific [Wh/kg] or volumetric [Wh/1] energy density. A cell with high energy density is contingent on a combination of two electrode materials with high charge density and potential difference.

Li-ion batteries can be divided into energy-optimized batteries, with high energy densities, low power densities and average discharge currents, and power-optimized batteries, with relatively low energy densities, high power densities, and discharge currents that are briefly very high. The former are important particularly for battery-electrically operated vehicles (BEVs), as the range of the vehicle is dependent on the capacity. With hybrid-electric vehicles (HEVs), conversely, exacting requirements are imposed on the power density and hence also on the high-current capability during charging and discharge.

The life of an Li-ion battery is defined as the timespan between the moment of handover (beginning of life, BoL), characterized by usually defined properties in the specification of requirements, and the moment (end of life, EoL) at which aging causes these properties to fall below a predefined value. EoL for batteries in electric vehicles is usually reached when the storage capability falls to less than 80% of the nominal capacity. In measuring the life, a distinction is made between cycle lifetime or cycling stability and calendar lifetime. Aging refers to a deterioration in the electrochemical properties (for example lower capacitance, higher internal resistance, etc.). This is governed very largely by the energy throughput or cycling. High power requirements during charging and discharge of the battery result in a high level of internal heat production. As a result, the electrode materials used may be irreversibly damaged and the aging of the cell or the system directly influenced and accelerated. Capacitance decreases with time; there is a rise in the internal resistance and a corresponding decrease in power. Secondary reactions which occur in the electrolyte during charging, such as expansion events on the part of the active materials, or else the mechanical work done by the active masses, for example, likewise have an impact on aging.

In present constructions for lithium-ion accumulators, the lithium atoms are supplied by the cathode. They are intercalated reversibly into the interstitial spaces in a lithium metal oxide lattice (FIG. 1). For example, commercial nickel manganese cobalt (NCM 622) cathodes have a storage density of up to 210 mAh/g. To provide sufficient capacitance for high-capacitance battery cells, the layer thickness of the cathode is increased accordingly, to allow balancing to take place with the anode. Balancing refers to the ratio of the absolute capacitance of cathode and anode. Typical ratios are from 1:1 to 1:1.3 (cathode:anode); for reliable operation, the anode is made larger in order to prevent lithium plating. If, during charging/discharge, lithium is removed from the cathode beyond a limiting value, the lattice structure of the metal oxide lattice suffers collapse and lithium can no longer be reversibly introduced. The lithium iron phosphate (LiFePO₄) used, which is more favorable but has a lower storage density (up to 160 mAh/g), is significantly more robust. Usually, therefore, as already mentioned, battery capacitance is limited by the cathode capacitance.

In the initial cycles of a lithium-ion battery, in particular, losses occur due to the decomposition of the electrolyte and the consequent buildup of an SEI (solid-electrolyte interphase). Both here and during the first charging of the anodes, there are irreversible lithium losses which must be taken into account in cell construction and in balancing. The limited lithium capacity of the cathodes cannot be sustainably increased (FIG. 2c).

Additional introduction of lithium, especially to compensate the initial losses, is therefore possible only by way of the anode.

Existing solutions utilize the prelithiation of the anode, by using reactive lithium supplied as powder or in the molten state to the battery in dry processes. By a dry process is meant a water-free or solvent-free process. A further possibility is that of the simple bringing-into-contact of a lithium foil with the anode intended for lithiation, where the high rate of diffusion of lithium means that prelithiation takes place even at temperatures in the region of room temperature.

A technically complicated prelithiation process involves the construction of an Si—Li half-cell and the electrochemical charging of the Si anode with lithium. Another possibility is to use an excess of lithium salts in the electrolyte so as to compensate the initial losses of the battery. The amount of lithium which is added to the battery is difficult to control, presenting a problem. A further aspect is the use of nanostructures, which prevents uniform prelithiation. Moreover, retrospective prelithiation in a dry process takes place only superficially and the anode, consequently, is generally very reactive and difficult to handle, comparable to pure lithium foil. Addition in powder form is difficult to control, and the cell again contains pure reactive lithium, which is highly reactive, hygroscopic, and oxidizes very quickly. The high reactivity of the lithium commonly results in pronounced SEI formation, leading to high cell resistances during battery operation.

Furthermore, high sheet currents, as are typical of high-performance batteries, lead to formation of dendrites, i.e. treelike or bushlike crystal structures, which puncture the separator and lead to short circuits.

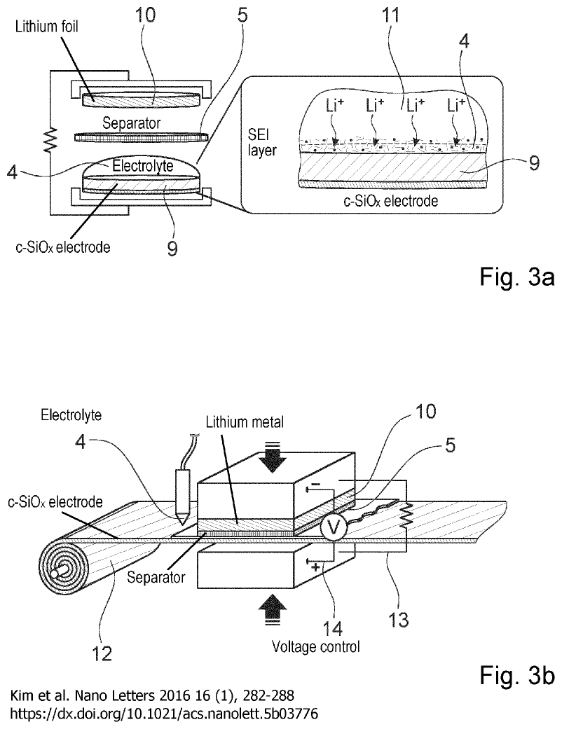

For electrochemical prelithiation there are design concepts for a roll-to-roll facility-see FIG. 3; however, the design concept is highly complex.

FIG. 3a shows schematically the process of the prelithiation of a c-SiOₓ electrode 9. Between the c-SiOₓ electrode 9 and a piece of lithium metal foil 10, in the presence of an electrolyte 4 and a separator 5, an electrical short circuit is produced and hence spontaneous prelithiation is initiated by the potential difference between the two electrodes (FIG. 3a). The rate of prelithiation can be controlled by means of the installed resistor 13. The endpoint of the prelithiation is determined by the cell voltage 14, which is monitored throughout prelithiation. FIG. 3b shows the prelithiation process in a roll-to-roll coating operation.

It is therefore the object of the present invention to specify a method which is suitable for introducing additional lithium into the silicon electrode, particularly so as to compensate the initial losses, and which is suitable for industrial use, but without exhibiting the disadvantages of the prior art.

This object is achieved by a method according to independent claim 1. In the method of the invention for producing a silicon electrode as an anode for a lithium-ion battery, wherein a stratified silicon construction is applied to a carrier substrate, the invention provides for the silicon electrode to be subjected to prelithiation by introduction of lithium into the stratified silicon construction by a process. A stratified silicon construction is characterized by the repeated application of silicon and, optionally, other functional layers to a substrate (a multilayer or multiple stack). A protective layer is applied and the introduced lithium is subjected to metered and diffusion-controlled reaction with the stratified silicon construction to form lithium silicide by subsequent accelerated annealing with a targeted energy input.

Accelerated annealing refers in particular to flash-lamp annealing and/or laser annealing. Flash-lamp annealing takes place with a pulse duration or annealing time in the range from 0.3 to 20 ms and a pulse energy in the range from 0.3 to 100 J/cm². In the case of laser annealing, the annealing time of 0.01 to 100 ms is established through the rate of scanning of the local heating site, to generate an energy density of 0.1 to 100 J/cm². The heating ramps achieved in the accelerated annealing are situated in the range, necessary for the method, of 10\hat{ }4-10\hat{ }7 K/s. Flash-lamp annealing for this purpose utilizes a spectrum in the visible wavelength range, whereas for laser annealing, discrete wavelengths in the range of the infrared (IR) to ultraviolet (UV) spectrum are used.

The method of the invention allows a defined amount of lithium to be incorporated into the silicon electrode without great cost and complexity. As a result, initial losses during start of battery operation can be compensated in a targeted way, permitting much easier balancing of cathode and anode in the lithium-ion batteries.

An advantage is the automatic deposition of a further covering layer, which acts as a protective layer, such as silicon or carbon, so that simple further-processing of the anode is assisted.

In the method of the invention, the subsequent accelerated annealing enables stabilization of the lithium layer. The targeted energy input enables the desired distribution of the lithium in silicon and, if possible, a reaction to form lithium silicide with control over diffusion; in other words, when saturation has taken place, the reaction to form lithium silicide comes to an end.

An advantageous energy input is achieved if the flash-lamp annealing is carried out with a pulse duration in the range from 0.3 to 20 ms, with a pulse energy in the range from 0.3 to 100 J/cm², and with preheating or cooling in the range from 4° C. to 200° C.

Where the accelerated annealing used is laser annealing, diffusion and reaction of metal with the silicon are controlled by an annealing time in the range from 0.01 to 100 ms by the establishment of a rate of scanning of a local heating site and an energy density in the range from 0.1 to 100 J/cm² and also by preheating or cooling in the range from 4° C. to 200° C. in the laser annealing.

In one embodiment of the method of the invention, the lithium is introduced into the stratified silicon construction in a dry process. This is only possible because of the unique stratified silicon construction. The particular feature of the stratified silicon construction is the presence of multiphases in the region of the silicon layer and of the metal substrate, with the multiphases consisting of amorphous silicon and/or crystalline silicon of the silicon in the silicon layer, and of crystalline metal of the metal substrate, and of silicide. The multiphase Si stratum layer has free spaces for accommodating the change in volume on lithiation and it therefore provides for stabilization of the overall material assembly. The lithium in this case may be incorporated by means of a dry process, for example by cathodic sputtering, in any desired amount, as an intermediate layer, and may be provided subsequently with a protective layer.

In a further embodiment of the method of the invention, therefore, the lithium is introduced into the stratified silicon construction by controlled sputtering. Sputtering is a controllable method allowing precise control over the amount of lithium to be introduced into the silicon electrode. The lithium in this case takes the form of a target, in solid form.

In a different further embodiment of the method of the invention, the lithium is introduced into the stratified silicon construction by controlled thermal vaporization. Thermal vaporization is a controllable method allowing precise control over the amount of lithium to be introduced into the silicon electrode. The lithium in this case is initially in solid form, and is liquefied and subsequently evaporated.

In another embodiment of the method of the invention, the lithium is introduced into the stratified silicon construction by thermally assisted rolling. Thermally assisted rolling, while being a less precise method for introducing lithium into the silicon electrode, is nevertheless very easy to carry out. The lithium in this case is in solid form.

In one embodiment of the method of the invention, the lithium is introduced into the stratified silicon construction by lithium melt deposition under vacuum or in an inert gas atmosphere. Lithium melt deposition under vacuum or in an inert gas atmosphere is again a less precise method for introducing lithium into the silicon electrode, but again is easy to carry out. The lithium in this case takes the form of a starting material in liquid form. The particular feature of lithium melt deposition is the ease with which the deposition process can be integrated into a flat roll-to-roll process, in which the lithium is introduced as an intermediate layer into the stratified silicon construction. Preliminary functionalization of the copper layer, i.e. of the current collector, for example by application of a silicon stratum in order to boost the wettability for liquid lithium, is readily possible.

In another embodiment of the method of the invention, the lithium is introduced separately as an individual layer or is introduced as a mixed layer, more particularly of lithium and silicon.

In one embodiment of the method of the invention, the protective layer is deposited from silicon or carbon or copper. The protective layer may additionally be formed from one or more strata of an artificial solid-electrolyte interphase (SEI), which is deposited in a vacuum or inert-gas process, e.g. an ALD (atomic layer deposition) process. It is advantageous if the artificial SEI is formed from Al₂O₃, TiO₂, SiO₂ and/or LiOH, since these prevent further oxidation and are nevertheless sufficiently permeable to Li+ ions during battery operation.

The method of the invention may be used advantageously for producing silicon electrodes as anodes in battery cells, wherein the lithium is added away from the cathode into the battery cell. Introduction of lithium away from the cathode means that the lithium is not added to the battery cell via the cathode. This is the case with innovative types of cell, examples being the cell types of the 3rd-generation lithium-sulfur (Li—S) batteries. The designation “3rd-generation” serves as a distinction from the Li-ion batteries (2nd generation), because the transport between cathode and anode takes place not via Li+ ions but instead via a compound of Li₂S. The targeted introduction of lithium into the silicon electrode as an anode, or the prelithiation, enables new and innovative cell design concepts for which hitherto only highly reactive lithium in foil form appeared possible.

The method of the invention may advantageously likewise be used in lithium-sulfur (Li—S) batteries. Especially for resource-preserving Li—S battery constructions with sulfur as cathode material, the Si anode produced in the invention is therefore considered ideal. Sulfur as cathode material has the highest known lithium storage density, at up to 1600 mAh/g. It therefore makes batteries possible with extremely high volume-based and gravimetric energy density. Both sulfur and silicon are plentiful resources; together with the metered introduction of lithium, this design concept represents the most resource-preserving deployment of a reusable lithium battery.

The method of the invention may advantageously likewise be used for the construction of a lithium-ion battery with a lithium nickel manganese cobalt oxide (NMC), a lithium nickel cobalt aluminum oxide (NCA) or a lithium iron phosphate (LFP) cathode.

The invention will be elucidated in more detail below with reference to an exemplary embodiment.

In the drawings

FIG. 1 shows an illustrative construction and function of a lithium-ion cell during discharging;

FIG. 2 shows the influence of prelithiation on the availability of lithium in the initial charging cycles of a lithium-ion battery;

FIG. 3 shows a representation of a) the prelithiation, and also the use in a roll-to-roll production operation;

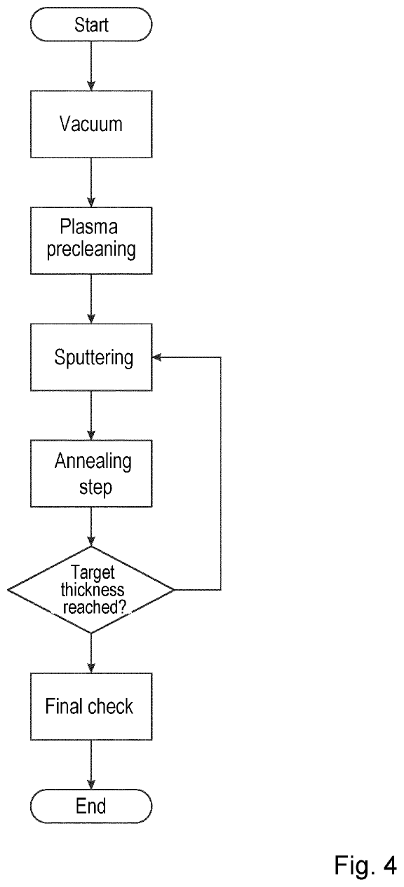

FIG. 4 shows a schematic representation of the method of the invention for producing a silicon electrode as an anode for a lithium-ion battery;

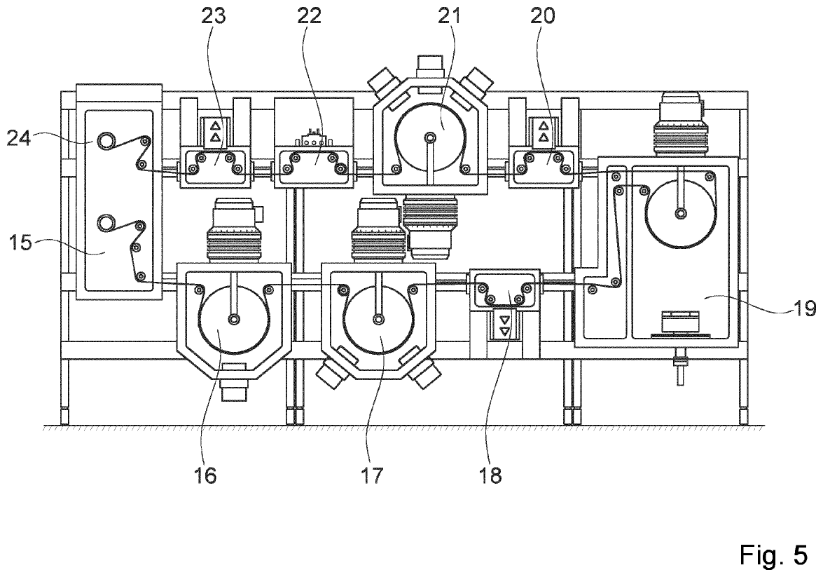

FIG. 5 shows a schematic representation of a facility for implementing the method of the invention;

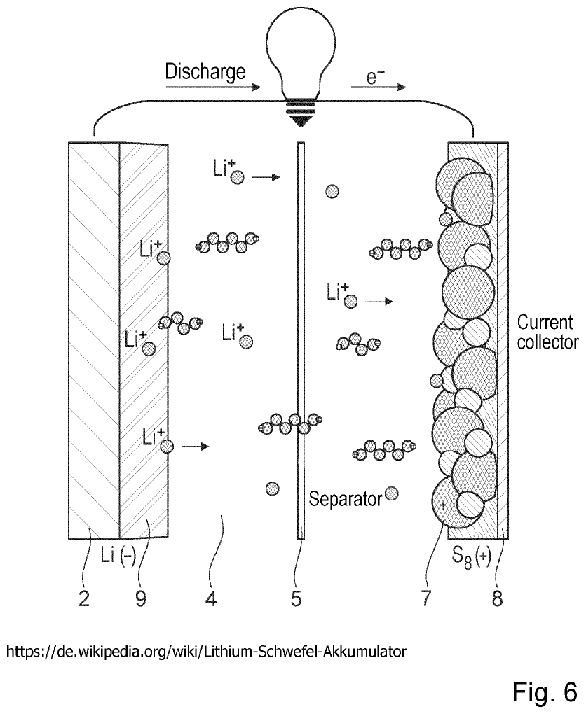

FIG. 6 shows the use of the Si anode, produced with the method of the invention, in an Li—S battery;

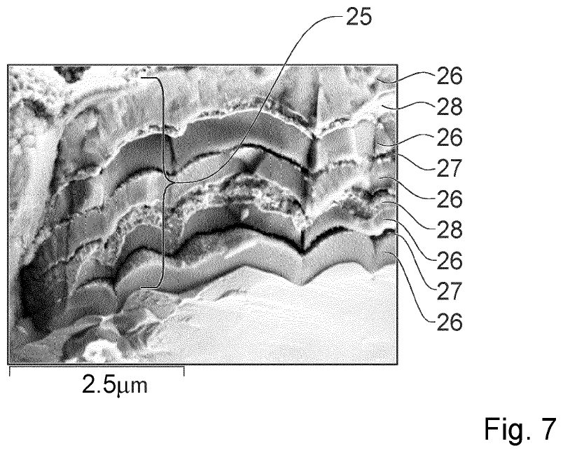

FIG. 7 shows an SEM-SE micrograph of an active layer of 3 μm of silicon interrupted by respectively 100 nm of copper and 100 nm of lithium produced by the method of the invention.

FIG. 4 shows the method steps of the invention in a flow diagram. A substrate which serves simultaneously as current collector undergoes precleaning under vacuum conditions in a plasma atmosphere. This is followed by stratified silicon construction and prelithiation via sputtering. Here, an Si/Li layer is applied sequentially, the strata being stabilized by flash-lamp annealing. The flash-lamp annealing enables a targeted energy input which can be used to control the stratified silicon construction to form lithium silicide in a metered and diffusion-controlled manner; in other words, once saturation has been reached, the reaction to form lithium silicide comes to an end. Preferred process parameters in the flash-lamp annealing are in the range from 0.3 to 20 ms for the pulse duration, in the range from 0.3 to 100 J/cm² for the pulse energy, and preheating or cooling in the range from 4° C. to 200° C. is advantageous. The layers are applied by sputtering in different strata, and stabilized via the flash-lamp annealing, until a desired target thickness is obtained. This method is very easy to implement.

FIG. 5 shows schematically an illustrative facility for a roll-to-roll coating operation for implementing the method of the invention. For the production of the Si electrode as anode 9, a silicon layer or stratified Si construction is applied to a metal substrate 2. From a first roll at the belt start 15, for example, a copper foil is passed through the facility. Sputtered onto this foil in alternation are a functional layer, followed by strata of silicon and lithium 16, 17, which are subjected to accelerated annealing 18 by means of a flash lamp. The belt can at any time be run forward and backward through the facility for application of a desired layer structure. Up to three sources can be installed in the chambers 16, 17, 21, allowing the deposition of up to three different materials per chamber. Accordingly, lithium could be introduced in every chamber. What is important, however, is the embedment into a layer stack, so that no lithium gets to the surface. Subsequently, by thermal vaporization 19, silicon is applied and a controlled conversion into lithium silicide is brought about by accelerated annealing, more particularly flash-lamp annealing, 20. Further strata may be applied by sputtering 21. A concluding treatment in a (reactive) plasma 22 is possible, and also a final accelerated annealing, more particularly flash-lamp annealing, 23 to finalize the stack. The coated substrate is wound up again onto a roll 24. The possibilities afforded by accelerated annealing, more particularly flash-lamp annealing, after the application of the stratified silicon construction include the formation of a porous silicide matrix, in which amorphous or nanocrystalline silicon occurs together with cavities or pores. A silicide matrix, however, is not absolutely necessary.

FIG. 6 shows the use of the Si electrode produced with the method of the invention as anode 9 in an Li—S battery. The targeted introduction of lithium into the silicon anode 9, or the prelithiation, enables new and innovative cell design concepts for which hitherto only highly reactive lithium in foil form appeared possible. Especially for resource-preserving Li—S battery constructions with sulfur as cathode material, the Si anode produced with the method of the invention is considered ideal. Sulfur as cathode material has the highest known lithium storage density, at up to 1600 mAh/g. Both sulfur and silicon are plentiful resources; together with the metered introduction of lithium, this design concept represents the most resource-preserving deployment of a reusable lithium battery.

The SEM-SE image in FIG. 7 shows an active layer with a layer sequence 25 of 3 μm of silicon 26 interrupted respectively by 100 nm of copper 28 and 100 nm of lithium 27. The materials were deposited via sputtering in the facility represented in FIG. 5.

### LIST OF REFERENCE SIGNS

1 lithium-ion battery
2 collector on anode side
3 SEI—solid-electrolyte interphase
4 electrolyte
5 separator
6 conducting interphase
7 cathode, positive electrode
8 collector on cathode side
9 anode, negative electrode
10 lithium foil
11 lithium ions
12 roll
13 resistor
14 cell voltage
15 belt start
16 first sputtering, sputter module
17 second sputtering, sputter module
18 first flash-lamp annealing, accelerated annealing
19 thermal vaporization
20 second flash-lamp annealing, accelerated annealing
21 third sputtering, sputter module
22 plasma cleaning
23 third flash-lamp annealing, accelerated annealing
24 belt end
25 stratified silicon construction
26 silicon
27 lithium
28 copper

1. A method for producing a silicon electrode as an anode for a lithium-ion battery, wherein a stratified silicon construction is applied to a carrier substrate, characterized in that the silicon electrode is subjected to a prelithiation by introduction of lithium into the stratified silicon construction by a process, in that a protective layer is applied and in that the introduced lithium is subjected to metered and diffusion-controlled reaction with the stratified silicon construction to form lithium silicide by subsequent accelerated annealing with a targeted energy input.

2. The method for producing a silicon electrode as an anode for a lithium-ion battery as claimed in claim 1, characterized in that the lithium is introduced into the stratified silicon construction in a dry process.

3. The method for producing a silicon electrode as an anode for a lithium-ion battery as claimed in claim 1, characterized in that the lithium is introduced into the stratified silicon construction by controlled sputtering.

4. The method for producing a silicon electrode as an anode for a lithium-ion battery as claimed in claim 1, characterized in that the lithium is introduced into the stratified silicon construction by controlled thermal vaporization.

5. The method for producing a silicon electrode as an anode for a lithium-ion battery as claimed in claim 1, characterized in that the lithium is introduced into the stratified silicon construction by thermally assisted rolling.

6. The method for producing a silicon electrode as an anode for a lithium-ion battery as claimed in claim 1, characterized in that the lithium is introduced into the stratified silicon stack by lithium melt deposition under vacuum or in an inert gas atmosphere.

7. The method for producing a silicon electrode as an anode for a lithium-ion battery as claimed in claim 1, characterized in that the lithium is introduced separately as an individual layer.

8. The method for producing a silicon electrode as an anode for a lithium-ion battery as claimed in claim 1, characterized in that the lithium is introduced as a mixed layer, more particularly of lithium and silicon.

9. The method for producing a silicon electrode as an anode for a lithium-ion battery as claimed in claim 1, characterized in that the protective layer is deposited from silicon or carbon or copper.

10. The method for producing a silicon electrode as an anode for a lithium-ion battery as claimed in claim 9, characterized in that the protective layer is additionally formed from one or more strata of an artificial solid-electrolyte interphase, SEI, which is deposited in a vacuum or inert-gas process.

11. The method for producing a silicon electrode as an anode for a lithium-ion battery as claimed in claim 10, characterized in that the artificial SEI is formed from Al₂O₃, TiO₂, SiO₂ and/or LiOH.

12. The use of the method for producing a silicon electrode as an anode for a lithium battery as claimed in claim 1 in battery cells, wherein the lithium is added away from the cathode into the battery cell.

13. The use of the method for producing a silicon electrode as an anode for a lithium battery as claimed in claim 1 for the construction of a lithium-sulfur battery, with sulfur as cathode material.

14. The use of the method for producing a silicon electrode as an anode for a lithium battery as claimed in claim 1 for the construction of a lithium-ion battery with a lithium nickel manganese cobalt oxide, NMC, a lithium nickel cobalt aluminum oxide, NCA, or a lithium iron phosphate, LFP, cathode.
